(19) United States
(12) Patent Application Publication
(10) Pub. No.: US 2004/0122711 A1
(43) Pub. Date: Jun. 24, 2004

(54) System and method for the optimization of the delivery of hospital services

(75) Inventors: Aragon B. Miller, La Selva Beach, CA (US); Creighton A. Miller, Aptos, CA (US)

Correspondence Address: BAKER BOTTS L.L.P., PATENT DEPARTMENT, 98 SAN JACINTO BLVD., SUITE 1500, AUSTIN, TX, 78701-4039, US

(73) Assignee: Mediware Information Systems Inc., Lenexa, KS

(21) Appl. No.: 10/325,895

(22) Filed: Dec. 20, 2002

(51) Int. Cl. G06F 17/60

(52) U.S. Cl. 705/2

(57) ABSTRACT

A system and method for the optimization of the delivery of hospital services includes a collection engine collecting a plurality of hospital event data, a clinical engine, and one or more rules for processing the hospital event data. The clinical engine monitors the hospital event data for one or more repeated occurrences and applies the rules to the hospital event data. If the hospital event data satisfies one or more of the rules as determined by the clinical engine, the clinical engine generates one or more recommendations where the recommendations regard altering the hospital services. The system and method may further include a clinical editor displaying within a user interface of one or more terminals the hospital event data, an indicator, and the recommendations. The system and method allows for the hospital services to be altered in accordance with the hospital event data describing actual events in the hospital.

### TECHNICAL FIELD OF THE INVENTION

The present invention relates generally to information processing, and more specifically relates to a system and method for the optimization of the delivery of hospital services.

### BACKGROUND OF THE INVENTION

The delivery of hospital services to patients requires a large amount of information and information processing regarding a patient and a medical procedure from before the patient checks into a hospital for the medical procedure until after the patient returns home. Hospital services include patient and non-patient activities such as collecting and logging all the required patient information, scheduling the patient operations, determining and gathering the necessary medical supplies and personnel for the operative event, pre-operative consultations, laboratory and x-ray work, the actual operations, patient post-operative care, billing the patients, medical supply inventory management, and any other activities performed in a hospital relating to patient care and hospital management. Each hospital service has a corresponding set of information that must be recorded and stored for such purposes as administration and record keeping, regulatory compliance, insurance reimbursement, and internal and external hospital billings.

The increasing amount of information required to be stored and processed by the hospitals has contributed to increasing costs in the delivery of the hospital services and in many cases has not resulted in improving the quality and efficiency of care. Furthermore, hospitals must gather and store information for record keeping purposes but many hospitals generally do not see a return on the time and money spent gathering and storing the information because the utilization of the information is expensive, difficult, and time consuming particularly when manually performed by the hospital staff. The cost and time associated with gathering and storing the hospital services information is passed on to the patient in the patient's medical bills resulting in higher medical bills or the cost is not recouped at all by the hospital.

### SUMMARY OF THE INVENTION

In accordance with the teachings of the present invention, a system and method for the optimization of the delivery of hospital services are described which substantially eliminate or reduce disadvantages with previous systems and methods for delivering hospital services. A clinical engine applying one or more rules to a plurality of hospital event data allows for the optimization of the delivery of hospital services by taking into account actual hospital event data in the delivery of the hospital services.

In accordance with one aspect of the present invention, a system for optimizing the delivery of hospital services is provided. The system includes a collection engine that collects a plurality of hospital event data. A clinical engine, associated with the collection engine, monitors the hospital event data for any repeated occurrences. Additionally, the clinical engine applies a plurality of rules to the hospital event data and generates one or more recommendations for the altering of the delivery of hospital services when the hospital event data satisfies one or more of the rules.

More specifically, when applying the rules to the hospital event data, the clinical engine determines if any of the hospital event data satisfies any of the rules. If the hospital event data satisfies one or more of the rules, the clinical engine generates one or more recommendations. A user is alerted to a generated recommendation by an indicator displayed by a clinical engine. The clinical editor displays within a user interface both the indicator and the hospital event data. If the user selects the indicator, the clinical editor displays a plurality of recommendation data thereby allowing the user to decide whether to accept or decline the recommendation. If the user accepts the recommendation, the clinical engine alters one or more of the hospital services in accordance with the accepted recommendation. If the user rejects the recommendation, the clinical engine does not alter the hospital service.

The present invention allows for a hospital to take advantage of all the information relating to the hospital services. The efficiency of the delivery of the hospital services increases because hospitals are able to alter the hospital services to more closely resemble what actually occurs in the hospital.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 represents a block diagram of an example system for the optimization of the delivery of hospital services;

FIG. 2 depicts an example user interface for charting;

FIG. 3 illustrates an example user interface for scheduling; and

FIG. 4 depicts a flow diagram of an example method for the optimization of the delivery of hospital services.

### DETAILED DESCRIPTION OF THE INVENTION

Preferred embodiments of the present invention are illustrated in the figures, like numerals being used to refer to like and corresponding parts of the various drawings.

Hospitals typically provide numerous hospital services every day from scheduling admissions and procedures, performing patient operations, and tracking patient care to administrative duties such as billing and inventory management. The performance and delivery of the hospital services requires a large amount of information processing regarding the patients, physicians, nurses, medical procedures, and the hospital. In order to provide safe and appropriate care, hospitals gather as much detailed information as possible regarding the patients and the medical procedures, insure that the information is accurate, and insure that all necessary medical accommodations are made and accounted for in order to minimize the risk to all patients from both a patient health concern as well as a malpractice liability concern.

Therefore, each hospital service has a plurality of hospital event data that corresponds with the hospital services. The hospital event data provides information to a physician, nurse, or hospital administrator regarding a particular hospital service. Hospital event data includes physician information, medical procedure information, patient information, supplies requested for a medical procedure, supplies actually used in a medical procedure, start and stop times for medical procedures, medical procedure outcomes based on both the type of procedure and the physician performing the procedure, scheduling information, charting information, the steps taken and the order of the steps taken by a physician, nurse, or hospital administrator when scheduling, charting, or performing a medical procedure, laboratory results, and any other appropriate medical information relating to the performance or delivery of hospital services.

Because of the number and range of hospital services provided by hospitals each day, hospitals have a large amount of hospital event data that can provide an indication as to how a hospital is performing. Typically, the hospitals store the hospital event data but the utilization of the hospital event data to evaluate or increase the efficiency of the operation of the hospital is a difficult, expensive, and time consuming procedure and therefore may not be performed by the hospital. The stored hospital event data is generally accessed for rare occasions such as quality review audits, inventory management, or as evidence in a potential malpractice claim to determine what steps and procedures were actually performed in a patient's case.

By contrast, the example embodiment described herein allows for the utilization of the hospital event data in order to optimize the delivery of the hospital services. Additionally, the example embodiment allows for the automated analysis of the hospital event data resulting in the creation of recommendations to alter the hospital services in order to increase efficiency. Time and money is saved because the hospital event data is collected and analyzed but hospital employees do not have to manually examine the hospital event data nor make recommendations as to how to alter the hospital services. Therefore, hospital employees' time may be better utilized providing patient care. Furthermore, the altering of the hospital services based on the rule application of the hospital event data creates a more efficient hospital that operates smoothly and that provides the same services at a lower cost.

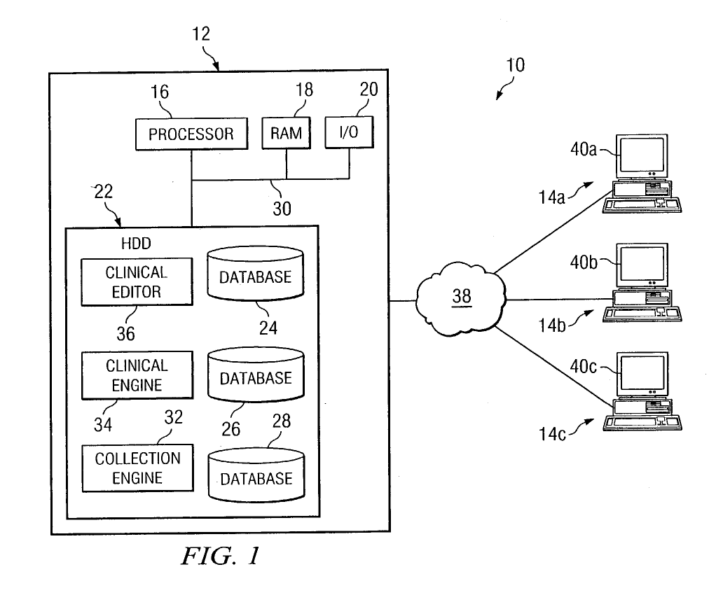

Referring now to FIG. 1, a block diagram depicts information system for the optimization of the delivery of hospital services. In the example embodiment, information system 10 includes clinical system 12 and three terminals 14a, 14b, and 14c. In alternate embodiments, information system 10 may include more than three or less than three terminals 14.

Clinical system 12 may include respective software components and hardware components, such as processor 16, memory 18, input/output port 20, hard disk drive (HDD) 22 containing databases 24, 26, and 28, and those components may work together via bus 30 to provide the desired functionality. The various hardware and software components may also be referred to as processing resources. Clinical system 12 may be a personal computer, a server, or any other appropriate computing device. Clinical system 12 also includes collection engine 32, clinical engine 34, and clinical editor 36, which reside in memory such as HDD 22 and are executable by processor 16 through bus 30. Although the embodiment shown in FIG. 1 includes three databases, in alternate embodiments clinical system 12 may include more than three or less than three databases.

Terminals 14 are computing equipment in communication with clinical system 12 via network 38. Terminals 14 may be personal computers, servers, handheld computing devices such as personal digital assistants (“PDA”), or any other appropriate computing devices, and may be equipped for connectivity to wireless or wireline networks. Terminals 14 may be remotely located from clinical system 12 throughout a hospital in an operating room, patient's room, nursing station, physician's office, laboratory, x-ray site, or any other appropriate location. In addition, terminals 14 may be remotely located from the hospital, such as in an administrative office or other hospital related business office and communicate with clinical system 12 using network 38. For example, terminal 14a may be located in a hospital administrator's office, terminal 14b may be located in an operating room in the hospital, and terminal 14c may be located at a nursing station. Terminals 14 interface with clinical system 12 and clinical system 12 interfaces with terminals 14 through network 38. Network 38 may be a public switched telephone network, the Internet, a LAN, a wireless network, or any other appropriate type of communication network.

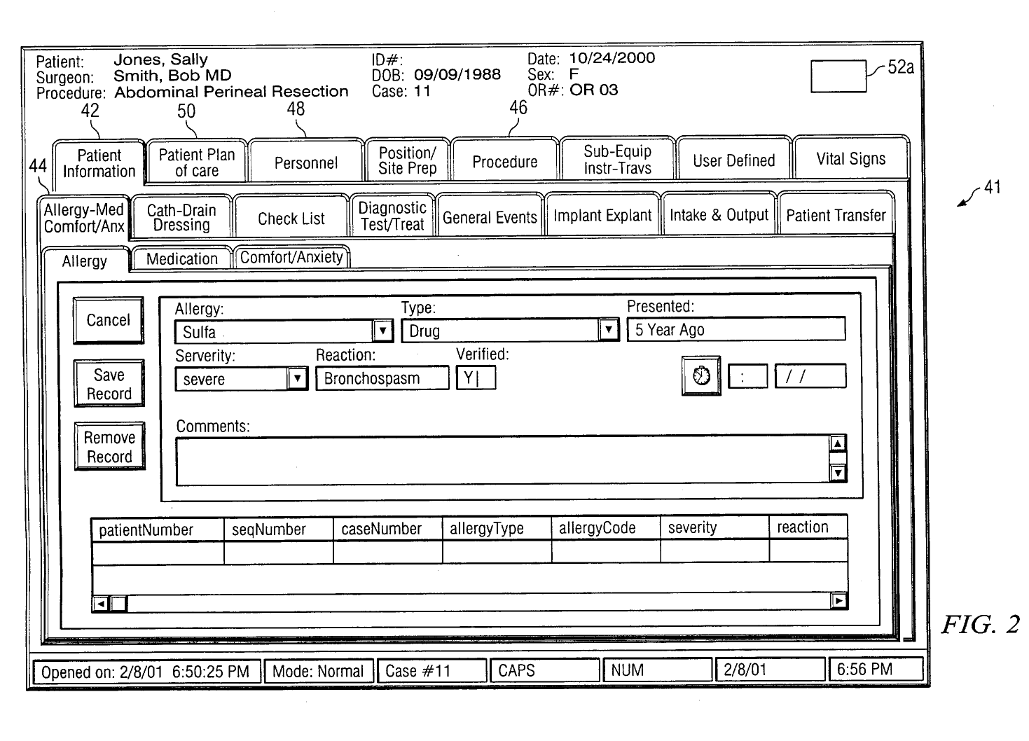

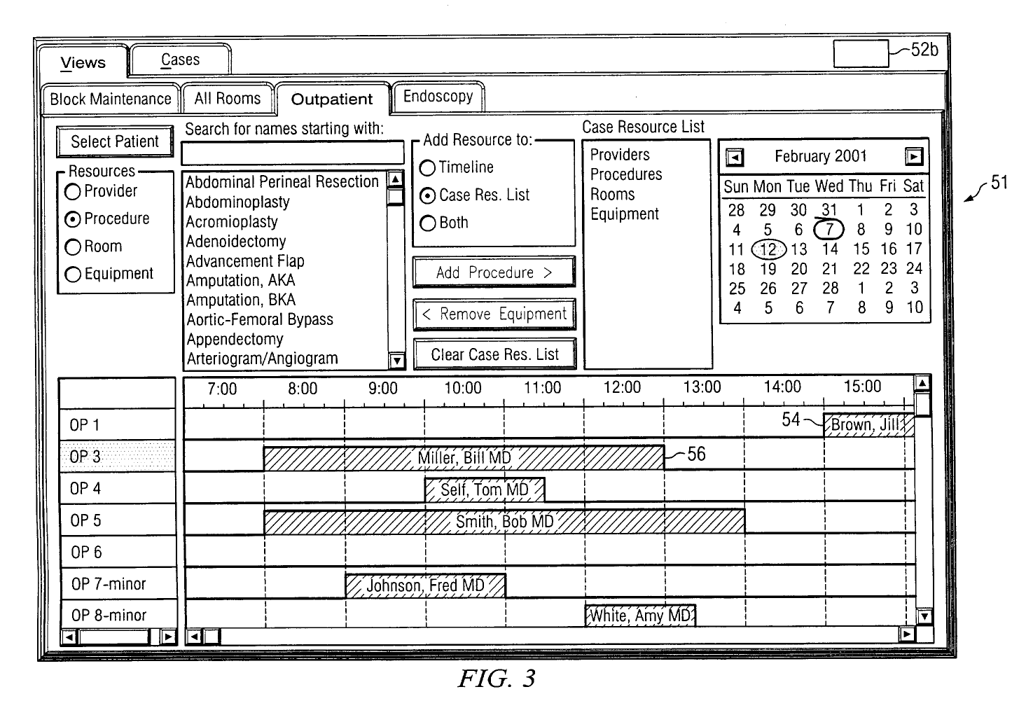

Terminals 14 further include monitors 40 and input devices such as a mouse and a keyboard. Monitors 40 present a user interface generated by clinical editor 36 to the users of terminals 14. The user interfaces allow the users to view the hospital event data and perform hospital services such as scheduling, determining preferences, and charting. In addition to terminals 14, clinical system 12 may also include a monitor to display the user interfaces generated by clinical editor 36. FIGS. 2 and 3 illustrate two example user interfaces that are discussed in greater detail below. FIG. 2 illustrates an example user interface for charting a surgical case and FIG. 3 depicts an example user interface for scheduling one or more medical procedures.

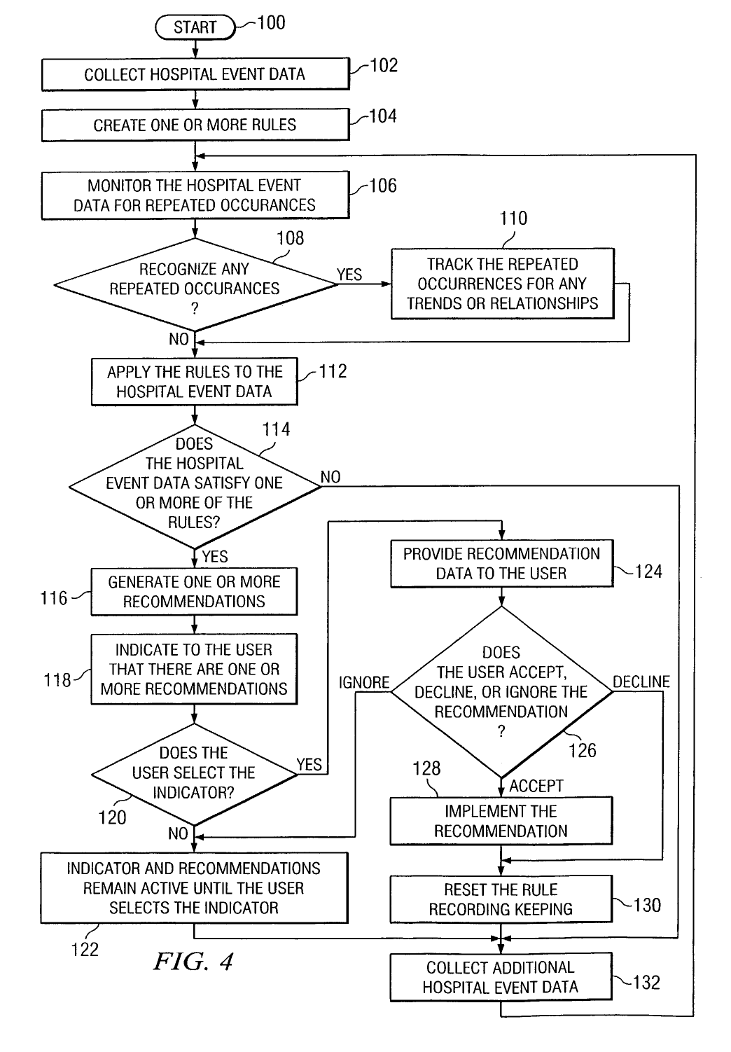

FIG. 4 depicts a flow diagram of an example method for the optimization of the delivery of hospital services. The method begins at step 100 and at step 102 collection engine 32 collects a plurality of hospital event data. Collection engine 32 collects the hospital event data by operating in the background whenever the users interact with terminals 14 and clinical system 12. For instance, during an operation a circulating nurse records the start and stop times for each procedure of the operation, the medical supplies used during each procedure, and the outcome of each procedure. The circulating nurse can record this hospital event data in real time utilizing a terminal 14 if one is located in an operating room or can manually record the hospital event data and at a later time manually enter the hospital event data into one of terminals 14. Collection engine 32 recognizes the start and stop times, medical supplies used, and outcomes as hospital event data and therefore collects that information as it is entered into one of terminals 14. Collection engine 32 collects other hospital event data such as scheduling and charting information as hospital staff schedules or charts cases, and also collects the steps taken and the order the steps were taken when performing a hospital service as the hospital service occurs. Once collection engine 32 collects the hospital event data, collection engine 32 may also store the collected hospital event data in one or more of databases 24, 26, and 28.

In addition to collecting hospital event data as the data is created and entered into terminals 14, collection engine 32 may also import a plurality of pre-existing hospital event data. A hospital may not have an existing computer system and wish to install information system 10 in order to better optimize the delivery of hospital services. Because there has been no computer system in the hospital's past, any pre-existing hospital event data has typically been keep manually. Collection engine 32 may be used to manually enter this pre-existing hospital event data, and thus imports the pre-existing hospital event data and collects the data into clinical system 12 so that the pre-existing hospital event data may be processed and analyzed as described below. Collection engine 32 may also import pre-existing hospital event data for hospitals that do have an existing computer system but desire to switch to information system 10. In those instances, collection engine 32 imports the pre-existing hospital event data from the existing computer system into clinical system 12. Furthermore, collection engine 32 has the ability to process the pre-existing hospital event data including schedules, surgical case data, physician preference data, and procedure preference data after importing the data into clinical system 12 and generate recommendations regarding the creation of data sets in information system 10 based on that imported hospital event data. For example, collection engine 32 may be used in the creation of an electronic preference database in information system 10 that includes the preference data for all the physicians and all the procedures that were in the pre-existing hospital event data. If the hospital decides to accept the recommendation for an electronic preference database, collection engine 32 stores the preference database as one of the databases 24, 26, or 28 in clinical system 12.

Once collection engine 32 has collected the hospital event data, at step 104 one or more rules are created which will be used by clinical system 12 to process the hospital event data in order to optimize the delivery of hospital services. The rules allow the users and clinical system 12 to apply thresholds to the hospital event data where the user can set the parameters that will trigger an action by clinical system 12. The rules allow clinical system 12 to recognize significant events and event trends within the hospital event data as separate from one-time events or random statistical variations.

Clinical system 12 allows for the users to create user-defined rules that are customized to the characteristics of each hospital. For example, with respect to preference data for a triple bypass surgery procedure, a user-defined rule may state that if a certain medical supply, such as a suture type, is not used in ten triple bypass procedures as evidenced by the hospital event data, that suture type should be recommended to be removed from the preference database of items to be prepared for that procedure. The users can specify the significance of an event with respect to how many times the event occurs, how many times the event occurs within a larger set of occurrences, or take into account the outcome of a procedure. A rule can be applied to the last five, ten, or any appropriate number of cases or a rule can utilize soft thresholds where the rule applies to the hospital event data such as if the rule is satisfied in the three of the last six instances of the hospital event data. A rule can be specified to any case in which a procedure occurred (covering multiple procedure cases), within cases in which only the specified procedure occurred, or only cases in which the specified procedure occurred in concurrence with other specified resources (useful for tracking specific physicians, equipment, supplies, or implants against outcomes and/or process flow). Additionally, rules can relate other data within information system 10 such as patient admission messages matching against existing patient data. Clinical system 12 may further include one or more default rules not created by the users which may be more general in nature and therefore apply to a wide variety of hospitals regardless of individual hospital characteristics.

Both the user-defined and default rules may be added, deleted, or modified at any time throughout the process of optimizing the delivery of hospital services and the rules may be customized with respect to specific items, procedures, physicians, outcomes, patient data, credentialing data, service groups, or schedules. The rules may apply to any aspect of the hospital services. For example, rules may exist for adding, deleting, or modifying the preferences or items listed in procedure and/or physician preference data. The rules may be broad and apply to a group of procedures such as all cardiac procedures or all orthopedic procedures or to any supplies used in any types of procedures or be narrow and thus specific to a specific physician, a specific procedure, and/or a specific medical supply. For example, a broad and general rule may recommend removing a particular medical supply if it was not used in fifty medical procedures regardless of the procedure type. A rule may be more narrow and state that any medical supply not used in the last seven cardiac procedures should be recommended to be removed from the preference data. Further narrowing of the rules may includes a rule stating that a retractor not used in the last five heart valve replacement procedures performed by Dr. Smith should be recommended to be removed from the preference data for heart valve replacement procedures performed by Dr. Smith.

Rules may also exist with respect to the scheduling of cases. The hospital event data includes information regarding the length of procedures and the outcomes of the procedures. The rules utilize the length of the procedures and the outcomes to aid in optimally scheduling cases and to determine an expected outcome for current cases being scheduled. Such scheduling rules may also be utilized to predict required staffing, locate and resolve scheduling conflicts, determine which procedures tend to have a negative outcome and suggest scheduling those early in the day, and appropriately schedule between low priority procedures and high priority procedures. For instance, the hospital event data may show that a certain procedure always lasts five hours and requires 12 hours of post-operative intensive care. Therefore, a rule for that procedure may suggest always scheduling that procedure early in the morning to allow for sufficient hospital personnel to provide the necessary patient care.

In addition, the rules may also take into account past procedures, outcomes, and statistical occurrences with respect to the procedures and corresponding outcomes and suggest altering the clinical plan of care accordingly. For instance, the hospital event data may show that for an abdominal procedure lasting under four hours, the patient has a ten percent chance of developing an infection. But if the abdominal procedure lasts over four hours, the patient has a ninety percent chance of developing an infection. Therefore if a physician is performing the abdominal procedure and the procedure is taking over four hours, a rule may notify the physician in the operating room through terminal 14 that the procedure is taking over four hours and that the patient has a ninety percent chance of developing an infection, and then recommend to the physician to give the patient additional antibiotics to prevent the infection. Alternatively, the rule may suggest altering the plan of care or the standing order to include the additional antibiotics at the four hour mark before the abdominal procedure begins so that the physician and nurses are prepared in advance if the procedure lasts over four hours. Additionally for the abdominal procedure, the rule may ask the physician if she wants to be reminded about using the additional antibiotics at the four hour mark if the procedure lasts over four hours and then at the four hour mark reminding the physician of the additional antibiotics.

Furthermore, the rules may apply to determine relationships between the hospital event data and suggest grouping the hospital event data accordingly. Preference data may be grouped into a cart group which is data that applies to all cases in a predefined set of cases such as cardiac cases or abdominal cases, a physician/cart group which is data that applies to all cases in a predefined set of cases such as cardiac case or abdominal cases performed by a specific physician, which are different from other physicians requirements for that same set of cases, a procedure group which is data that applies to all cases for a specific procedure, performed by any of the physicians at the hospital, a physician/procedure group which is data that applies to all cases for a specific procedure, performed by a specific physician, which are different from other physicians requirements for that particular procedure, a physician group which is data that applies to all cases of all types performed by a specific physician, which are different from other physicians requirements, or any other appropriate grouping. The rules may suggest specific groupings for preference data or suggest altering the current groupings based on the hospital event data. The grouping of the preference data allows for a more streamlined approach when gathering items from the preference data and results in a more efficient use of medical supplies.

After collection engine 32 collects the hospital event data, at step 106 clinical engine 34 monitors the hospital event data for any repeated occurrences. Repeated occurrences may be one repeated event, a series of repeated events, or a series of similar events for a hospital service with respect to how the hospital event data is entered into the user interfaces of terminals 14, supplies used, start times, stop times, and outcomes for medical procedures, the grouping of preference data, or necessary post operative care. For example, monitoring the hospital event data may indicate that every heart procedure in the hospital event data has required two days of recovery in intensive care and constant nurse care regardless of the physician performing the procedure and the age of the patient or that every cardiac procedure has included the same suture type.

Another type of repeated occurrence may relate to how a hospital service is performed and the particular user interface elements the hospital staff accesses when performing the hospital service. For instance, when charting a case using charting interface 41 shown in FIG. 2, a nurse may select various user interface elements, such as tabs 42-50, in a specific order. For example, the nurse may first select tab 42 to provide basic patient information, then select tab 44 to provide allergy information, then select tab 46 to provide medical procedure information, and finally select tab 48 to provide physician and nurse information. As the nurse selects the various tabs and provides information in the tabs, clinical engine 34 monitors the nursers actions and notes the tabs accessed by the nurse and the order in which the tabs were accessed by the nurse.

While monitoring for repeated occurrences, clinical engine 34 determines if it recognizes any repeated occurrences in the hospital event data at step 108. If there are no repeated occurrences at step 108, the process continues to step 112. If there are repeated occurrences at step 108, then at step 110 clinical engine 34 tracks the repeated occurrences for any trends or relationships. Each of the repeated occurrences are stored so that clinical engine 34 can use the rules to process both the hospital event data and the repeated occurrences within the hospital event data.

At step 112, clinical engine 34 applies the rules to the hospital event data including any of the repeated occurrences within the hospital event data. Clinical engine 34 applies the rules to the hospital event data by searching the hospital event data for information that satisfies the rules. For example, if a rule calls for adding a specific suture to cardiac surgery preference data if the specific suture is used in the last eight cardiac cases and is not currently listed in the preference data, clinical engine 34 searches the hospital event data for the last eight cardiac cases to see if the specific suture was used in any of the cases and if it is currently listed in the preference data. For repeated occurrences, a rule may state that if a repeated occurrence occurs a specified number of times, make a recommendation regarding the repeated occurrence. For instance, there may be a rule relating to repeated occurrences for charting a case. At step 110, clinical engine 34 recognized a repeated occurrence for charting a case using tabs 42, 44, 46, and 48 of charting interface 41. A rule may state that if a repeated occurrence for charting a case occurs five times, create a workflow template that simplifies charting a case and then recommend the workflow template to the user. The hospital event data reveals that in the last five cases charted, each nurse accessed tabs 42, 44, 46, and 48 in that order and did not access any of the other tabs so that repeated occurrence satisfies the rule.

Certain aspects of the hospital event data may be excluded from rule application. For instance, a general rule stating that any item of medical supplies not used in the last sixty procedures of any type should be recommended to be removed from the preference data for all procedures. But the preference data for every procedure may include safety equipment such as a fire extinguisher which should be included in the operating room for safety reasons and therefore never be recommended to be removed from the preference data. Therefore, even though a fire extinguisher has been on the preference data for the last sixty procedures and has not been used, clinical engine 34 will exclude the fire extinguisher from rule application and not recommend its removal even though it satisfies the rule.

After searching the hospital event data, at step 114 clinical engine 34 determines if the hospital event data satisfies any of the rules. If the hospital event data does not satisfy any of the rules at step 114, then the process continues to step 132 where collection engine 32 collects additional hospital event data that has been created since collection engine 32 last collected hospital event data at step 102. If at step 114 the hospital event data satisfies one or more of the rules, then at step 116 clinical engine 34 generates one or more recommendations.

The recommendations generated by clinical engine 34 relate to how to alter the hospital services for which the corresponding hospital event data satisfies one or more of the rules. For instance, with the case charting example above, there may be a rule relating to repeated occurrences for charting a case. The repeated occurrence of accessing tabs 42, 44, 46, and 48 of charting interface 41 satisfies the rule. Therefore as a recommendation, clinical engine 34 automatically recommends creating a workflow template that leads the user through charting a case by taking the user through the tabs the user will want to populate in the same order the user has previously accessed the tabs—here tab 42, next to tab 44, then to tab 46, and finally to tab 48.

Clinical engine 34 may also make recommendations as to preference data for physicians and procedures. As discussed above, rules may exist for adding, deleting, or modifying the items listed in the preference data. Based on how specific preferences are used or not used in actual procedures, clinical engine 34 will recommend adding an item to the preference data if it is not already part of the preference data but is used in the actual procedures or recommend removing an item from the preference data if that item is included in the preference data but not used in the actual procedure. In addition to altering preference data, clinical engine 34 also utilizes the rules to make recommendations regarding the grouping of the preference data. For example, if all the physicians use the same retractors in a bypass procedure, clinical engine 34 will recommend moving the retractors into the procedure group for bypass procedures.

Clinical engine 34 may also apply the rules to the hospital event data regarding the scheduling of cases. Clinical engine 34 uses the length of the procedures and the outcomes to aid in optimally scheduling cases. The hospital event data allows clinical engine 34 to use actual data to determine typical outcomes and recovery times for each medical procedure overall and when preformed by a specific physician. For example, one certain procedure may require a large amount of post operative care no matter the physician performing the procedure. Therefore, that procedure should be scheduled early in the morning instead of late in the day so that there will be plenty of available staff to provide the necessary post operative care.

After clinical engine 34 has generated one or more recommendations for the hospital event data satisfying the rules, the user must be notified that there are new recommendations. The user is alerted to the recommendations through a recommendation interface accessed using terminal 14 and/or by one or more indicators 52. The recommendation interface allows hospital personnel having the authority to accept or decline the recommendations, such as physicians or hospital administrators, the ability to view all the recommendations generated by clinical engine 34. The recommendation interface may be password protected so that only authorized hospital personnel will have access to the recommendations and the ability to accept or decline the recommendations.

In addition to the recommendation interface, clinical editor 36 creates one or more indicators 52 to indicate to the users that clinical engine 34 has one or more recommendations for altering the hospital services. Clinical editor 36 generates the user interface for clinical system 12 that is displayed in monitors 40 of terminals 14. The user interfaces, such as charting interface 41 and scheduling interface 51, allow the users to interact with clinical system 12. Clinical editor 36 creates indicators 52 for user interfaces for which a recommendation applies and where the user interacting with the user interface will have the necessary authority to view and accept or decline the recommendation. This prevents hospital personnel without authority, such as non-licensed hospital personnel, from seeing the recommendation and making any decisions regarding accepting or declining the recommendation. Indicators 52 alert the user that clinical engine 34 has generated one or more recommendations based on the hospital event data satisfying one or more of the rules. For instance, if clinical engine 34 creates a recommended workflow template for charting cases based on the hospital event data provided by the user utilizing charting interface 41 of FIG. 2, then clinical editor 36 displays indicator 52a on charting interface 41, which indicates one or more recommendations. In the embodiments shown in FIGS. 2 and 3, indicators 52 are located in the upper right-hand corner but in alternate embodiments indicators 52 may be located anywhere on the user interfaces. In addition, indicators 52 may be an icon that is present on interfaces 41 and 51 when there is a recommendation and not present on interfaces 41 and 51 when there is not a recommendation. Alternatively, indicators 52 may always be present on interfaces 41 and 51 and illuminate when there is a recommendation and not illuminate when there is not a recommendation.

Once clinical editor 36 displays indicator 52 to the user, the user must decide whether to select indicator 52 at step 120. If the user does not select indicator 52 at step 120, then at step 122 indicator 52 and associated recommendations remain active on the user interface until the user selects it at a later time and the process continues to step 132 where collection engine 32 collects additional hospital event data not yet collected.

If at step 120 the user selects indicator 52, then at step 124 clinical editor 36 provides a plurality of recommendation data to the user so that the user will be informed as to accepting or declining the recommendation. The recommendation data includes the recommendation, the hospital service as it currently exists in an unmodified state, and the hospital event data satisfying the rule that resulted in the generation of the recommendation. For example, if a nurse is determining the preference data for an orthopedic knee surgery for Dr. Miller, the nurse will access the preference data for the particular procedure and physician using one of terminals 14. When viewing the user interface for the preference data, the nurse will notice an active indicator on the user interface. After clicking on the indicator, the nurse will be presented with the current preference data, the recommendation to remove a specific clamp from the preference data, and the hospital event data showing how the clamp was not used in the last eight orthopedic knee procedures where the rule suggests removal of the clamp when eight procedures have not included the clamp but the clamp has been listed in the preference data.

Further, if a scheduling clerk is scheduling the daily operations using scheduling interface 51, after scheduling Dr. Brown's knee replacement procedure at 1:00 PM at bar 54, indicator 52b becomes active. Selecting indicator 52b results in clinical editor 36 displaying the recommendation to move Dr. Brown's knee replacement procedure to earlier in the morning and Dr. Miller's appendectomy, shown at bar 56, to later in the day, and the hospital event data showing that Dr. Brown's last five knee replacement procedures have required extensive post operative care and several dedicated nurses and the cases showing Dr. Miller's appendectomy requiring very little post operative care. Since the hospital has less nurses and physicians working in the late afternoon and evening shifts versus the morning and early afternoon shifts, the hospital will be better staffed to handle the post operative care of the knee replacement procedure earlier in the day.

After reviewing the recommendation data, at step 126 the user must decide to accept, decline, or ignore the recommendation. Clinical system 12 cannot automatically decide to accept, decline, or ignore the recommendations because the recommendations affect the hospital services and the medical care of patients and therefore competent medical intervention is required to alter the hospital services. Therefore implementation of the recommendations requires user intervention and user decision making. The recommendation may be ignored if the user does not want to currently decide on accepting or declining the recommendation. For example, a physician may not want to change the preference data without first consulting with her colleagues. If the recommendation is ignored, then the process continues to step 122 where the indicator and recommendation remain active until someone with the proper authority accepts or declines the recommendation.

If at step 126 the user accepts the recommendation, then at step 128 clinical engine 34 implements the recommendation and alters the hospital service in accordance with the recommendation. For instance, in the scheduling example provided above, if the user accepts the recommendation to move Dr. Brown's procedure to early in the day and Dr. Miller's procedure to later in the day, clinical engine 34 rearranges the schedule of procedures accordingly and insures there are adequate personnel for both procedures. Or if the recommendation is in regards to preference data, clinical engine 34 alters the preference data to add or remove particular preferences. With respect to workflow templates, if the user accepts the workflow template created by clinical engine 34, clinical engine 34 provides the workflow template to the users so that users may immediately begin using the workflow template.

After clinical engine 34 implements the recommendation at step 128 or if at step 126 the user declines the recommendation, then at step 130 clinical editor 36 removes indicator 52 as active from the user interfaces and removes the recommendation from the recommendation interface and clinical engine 34 resets the rule record keeping for the rule that resulted in the accepted or declined recommendation at step 126. For example, if the rule suggested a recommendation for a drape if it was not used in eight cases, then the eight cases used to satisfy the rule are removed from consideration of that rule but may still be used to satisfy other rules. The resetting of the rule record keeping is especially effective for when the user declines a recommendation. Because the rule record keeping has been reset, satisfaction of the rule will require eight new occurrences in the hospital event data before clinical engine 34 will make the same recommendation. If the rule was not reset, then after the rule is first satisfied at eight cases and the user declines, the recommendation would continue to be available to the users each time there is a new case because each new case would remove the oldest case but still result in eight case always satisfying the rule resulting in the user having to constantly decline the rule, and possibly becoming dissatisfied with information system 10.

Once the recommendation has been declined or accepted, the process continues to step 132 where collection engine 32 collects additional hospital event data that has been generated since collection engine 32 last collected hospital event data and information system 10 repeats step 106 through step 132 to continually collect, monitor, and apply the rules to the hospital event data.

After a recommendation has been implemented, clinical engine 34 continues to monitor the hospital event data and make recommendations including recommendations to the previously implemented recommendations. For example, when using a workflow template created by clinical engine 34, users can at any time deviate from the workflow template for alterations and then return to the workflow template when ready to proceed. As the users use the workflow template, clinical engine 34 continues to monitor the use of the workflow template and track any instances where the users exit from the workflow template to access other user interface elements not in the workflow template. A rule with respect to workflow templates may exist that states if the users exit from the workflow template at the same place and access the same user interface element five times, then recommend altering the workflow template to include the user interface element the users exited the workflow template to access. For example, users charting a case using the workflow template may exit from the workflow template after tab 44 to access tab 50 and then return to the workflow template. After exiting to access tab 50 occurs five times, clinical engine 34 determines that this hospital event data satisfies one of the rules and therefore clinical engine 34 recommends altering the workflow template to include tab 50 after tab 44 and before tab 46.

This present invention allows for the recommendations to be applied to recognize the differences between an actual activity and a preplanned activity, to optimize workflow, and to provide recommendations for modifications to expected usage based on actual activity resulting in a more efficiently operating hospital. Information system 10 allows for a decrease in the number of hours spent by hospital staff performing clerical or non-patient related activities and reduces the overall operating cost of the hospital.

Although the present invention has been described in detail, it should be understood that various changes, substitutions and alterations can be made hereto without departing from the spirit and scope of the invention as defined by the appended claims.

What is claimed is:

1. A method for the optimization of the delivery of hospital services, the method comprising:
collecting a plurality of hospital event data;
creating one or more rules for processing the hospital event data;
monitoring the hospital event data for one or more repeated occurrences;
applying one or more of the rules to the hospital event data; and
generating one or more recommendations when the hospital event data satisfies one or more of the rules.

2. The method of claim 1 wherein monitoring the collected hospital event data comprises tracking one or more user interface elements accessed by a user and an order in which the user accesses the user interface element

3. The method of claim 2 further comprising creating one or more workflow templates wherein the workflow templates include the user interface elements accessed by the user arranged in the order that the user accessed the user interface elements.

4. The method of claim 3 further comprising:
recommending one or more of the workflow templates to the user;
monitoring how the user interacts with the workflow template;
determining when the user exits from the workflow template in order to access one or more user interface elements not included in the workflow template; and
recommending an update to the workflow template if the user exiting from the workflow template satisfies one of the rules.

5. The method of claim 1 wherein collecting a plurality of hospital event data comprises importing a plurality of pre-existing hospital event data.

6. The method of claim 1 further comprising implementing the recommendation when a user accepts the recommendation.

7. The method of claim 6 wherein implementing the recommendation comprises altering the hospital service in accordance with the recommendation.

8. The method of claim 1 wherein applying one or more of the rules comprises determining if the collected hospital event data satisfies one or more of the rules.

9. The method of claim 1 further comprising providing an indicator to a user indicating the generation of one or more of the recommendations.

10. The method of claim 9 further comprising providing a plurality of recommendation data when the user selects the indicator.

11. The method of claim 1 further comprising recommending a preference database utilizing the hospital event data.

12. The method of claim 1 wherein generating one or more recommendations comprises recommending how to group a plurality of preference data into one or more groups.

13. A system for the optimization of the delivery of hospital services, the system comprising:
a collection engine operable to collect a plurality of hospital event data;
one or more rules for processing the hospital event data; and
a clinical engine associated with the collection engine, the clinical engine operable to monitor the hospital event data for one or more repeated occurrences, apply one or more of the rules to the hospital event data, and generate one or more recommendations when the hospital event data satisfies one or more of the rules.

14. The system of claim 13 wherein the clinical engine is further operable to:
create one or more workflow templates based on one or more of the repeated occurrences; and
provide the workflow template as one of the recommendations.

15. The system of claim 14 further comprising the clinical engine operable to:
monitor how a user interacts with the workflow template; and
recommend altering the workflow template based on the user interaction with the workflow template.

16. The system of claim 13 further comprising an indictor associated with the clinical engine, the indicator operable to indicate to a user that the clinical engine has generated at least one recommendation.

17. The system of claim 13 further comprising a clinical editor associated with the clinical engine, the clinical editor operable to display within a user interface the hospital event data, an indicator, and the recommendations.

18. The system of claim 17 further comprising the clinical editor operable to display a plurality of recommendation data when the user selects an indicator.

19. The system of claim 13 further comprising the collection engine operable to import a plurality of pre-existing hospital event data.

20. The system of claim 13 further comprising the clinical engine operable to:
determine one or more relationships between the hospital event data; and
recommend arranging the related hospital event data into one or more groups.

21. The system of claim 13 further comprising the clinical engine operable to implement the recommendation when a user accepts the recommendation.

22. The system of claim 21 wherein the clinical engine implements the recommendation by altering the hospital service in accordance with the recommendation.

23. The system of claim 13 further comprising one or more terminals including a user interface, the terminals operable to communicate with the clinical engine and a clinical editor.

24. The system of claim 13 further comprising the clinical engine operable to:
determine an expected outcome of a medical procedure by applying one or more of the rules to the hospital event data; and
generate a recommendation regarding altering a plan of care based on the expected outcome.

25. A method for tracking and processing a plurality of hospital event data relating to a plurality of hospital services, the method comprising:
collecting the hospital event data;
creating one or more rules for processing the hospital event data;
monitoring the collected hospital event data for one or more repeated occurrences;
storing the collected hospital event data in one or more databases;
applying one or more of the rules to the collected hospital event data;
searching the collected hospital event data for a plurality of information satisfying one or more of the rules;
determining if the collected hospital event data satisfies one or more of the rules; and
if the collected hospital event data satisfies one or more the rules, generating one or more recommendations, the recommendations regarding altering one or more of the hospital services.

26. The method of claim 25 wherein generating one or more recommendations comprises recommending altering one or more preferences in a plurality of preference data.

27. The method of claim 25 wherein generating one or more recommendations comprises recommending how to schedule one or more medical procedures.

28. The method of claim 25 wherein generating one or more recommendations comprises:
creating one or more workflow templates for the entering of the hospital event data; and
recommending one or more of the workflow templates to a user.

29. The method of claim 25 wherein generating one or more recommendations comprises recommending altering a plurality of preference data based on an expected outcome for a medical procedure, the expected outcome determined from the application of one or more of the rules on the collected hospital event data.
